(19) United States
(12) Patent Application Publication
(10) Pub. No.: US 2024/0378573 A1
(43) Pub. Date: Nov. 14, 2024

(54) GEOMETRIC DEEP LEARNING AND OPTIMIZATION OF PAYMENTS ON A SECOND-LAYER PAYMENT PROTOCOL NETWORK

(71) Applicant: Stillmark Management LLC, Los Angeles, CA (US)

(72) Inventor: Vikash R. Singh, San Francisco, CA (US)

(21) Appl. No.: 18/238,618

(22) Filed: Aug. 28, 2023

Related U.S. Application Data
(60) Provisional application No. 63/464,836, filed on May 8, 2023.

(51) Int. Cl. G06Q 20/06; G06Q 20/38

(52) U.S. Cl. CPC G06Q 20/0655; G06Q 20/389

(57) ABSTRACT

A method for managing a cryptocurrency transaction includes receiving information from a second-layer payment protocol network configured to process transactions between users of a cryptocurrency network. The information includes partial data indicating balances associated with user nodes in the second-layer payment protocol network or balances associated with channels between two or more of the user nodes. The method further includes obtaining additional data indicative of the balances associated with the user nodes or the balances associated with the channels, generating a graph neural network (GNN), receiving information associated with a requested transaction between user nodes in the second-layer payment protocol network, and, in response to the information associated with the requested transaction, calculating one or more paths for the transaction between the first user node and the second user node based on outputs of the GNN and outputting the one or more paths for execution of the transaction.

### CROSS-REFERENCE TO RELATED APPLICATIONS

This application claims the benefit of U.S. Provisional Application No. 63/464,836 filed May 8, 2023, the entire disclosure of which is incorporated by reference.

### FIELD

The present disclosure relates to transaction management for cryptocurrency networks.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Bitcoin, the oldest and most secure blockchain, uses a distributed ledger to record transactions. However, the scalability and transaction speed of Bitcoin is limited due to the consensus mechanism and block size constraints. For example, Bitcoin's base layer can only handle 5-10 transactions per second. To address these limitations, the Lightning Network was introduced as a second-layer payment protocol network built on top of blockchain networks like Bitcoin.

### SUMMARY

Further areas of applicability of the present disclosure will become apparent from the detailed description, the claims, and the drawings. The detailed description and specific examples are intended for purposes of illustration only and are not intended to limit the scope of the disclosure.

One embodiment of the present disclosure describes a method for managing a transaction that includes, by a computing device, receiving information from a second-layer payment protocol network configured to process transactions between users associated with a cryptocurrency network, wherein the information includes partial data indicating at least one of balances associated with user nodes in the second-layer payment protocol network or balances associated with channels between two or more of the user nodes. The method further includes obtaining, from the partial data, additional data indicative of the at least one of the balances associated with the user nodes or the balances associated with the channels, generating a graph neural network (GNN) based on the partial data and the additional data, receiving information associated with requested transaction between first and second user nodes in the second-layer payment protocol network, and, in response to the information associated with the requested transaction, calculating one or more paths for the transaction between the first user node and the second user node based on outputs of the GNN and outputting the one or more paths for execution of the transaction.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The present disclosure will become more fully understood from the detailed description and the accompanying drawings, wherein:

FIG. 1 is an example transaction management system for a Lightning Network, according to the present disclosure.

FIG. 2 illustrate steps of an example method for managing transactions over a Lightning Network, according to the present disclosure.

FIG. 3 is an example computing device configured to implement transaction management systems and methods, according to the present disclosure.

FIG. 4 is a functional block diagram of an example transaction management system for a Lightning Network, according to the present disclosure.

FIG. 5A illustrates example Lightning Network nodes, according to the present disclosure.

FIG. 5B illustrates example relationships between Lightning Network nodes to be input to a graph neural network, according to the present disclosure.

FIG. 5C illustrates a portion of an example graph neural network, according to the present disclosure.

FIG. 5D illustrates example Lightning Network nodes with predicted channel balance data, according to the present disclosure.

FIG. 6 illustrates steps of another example method for managing transactions over a Lightning Network, according to the present disclosure.

In the drawings, reference numbers may be reused to identify similar and/or identical elements.

### DETAILED DESCRIPTION

The present disclosure relates to the fields of cryptocurrency (e.g., Bitcoin) and artificial intelligence/machine learning and specifically to using graph neural networks on second-layer payment protocol networks (e.g., the Lightning Network) to facilitate scalable and efficient decentralized payments.

The Lightning Network enables off-chain, peer-to-peer transactions that are faster and cheaper compared to on-chain transactions. However, efficiently routing payments in the Lightning Network can still be challenging, especially given unknowns in network channel balances.

Deep learning has emerged as a powerful tool over the last decade in predictive tasks on images and sound. Deep learning systems may use convolutional neural networks (CNNs), recurrent neural networks (RNNs), and subsequent variants based on attention mechanisms (transformers). Graph Neural Networks (GNNs) are configured to analyze and process graph-structured data. Systems and methods according to the present disclosure implement GNNs for modeling the dynamic nature of the Lightning Network to provide scalable and efficient decentralized payments. More specifically, the systems and methods of the present disclosure leverage transaction data and known channel balance data which can be obtained either voluntarily or through probing mechanisms. GNNs can learn representations of nodes and edges or channels in a graph, capture their interactions, and make predictions or decisions, including optimizing payment routing decisions, based on the learned representations. Combining the Lightning Network with GNNs addresses the challenges of routing payments in a scalable and efficient manner and leverages GNNs for node operations and liquidity management.

The systems and methods of the present disclosure implement data preprocessing, model training, and payment routing optimization as described below in more detail. For example, data preprocessing includes collecting Lightning Network data, including, but not limited to: node attributes (e.g., node feature flags) and edge attributes (e.g., channel capacity, channel fees, etc.), and preprocessing the collected data to create a graph data structure suitable for GNN input. Additional data regarding channel balances in the network are collected or obtained through probing (sending fake payments), voluntary collection, and/or the like.

Model training includes training a GNN model using the preprocessed Lightning Network graph data and a supervised or unsupervised learning approach. The GNN model learns to encode node and edge attributes into low-dimensional representations and captures the dynamic interactions between nodes and edges in the graph. The model learns distributed representations or embeddings of nodes and edges/channels in the network and is trained to predict known channel balances in the Lightning Network. The output of the trained model includes predictions of channel balances across the Lightning Network. If time series information is available, an RNN can additionally or alternatively be used to project the channel balances, as well as a combination of a GNN and RNN to capture both the topological and temporal nature of the interactions. In some examples, as an alternative to a neural network approach, a Lightning Network simulator can also be used to mimic a set of transactions in the network and project channel balances (e.g., probabilistically) across a set of assumptions on transaction distribution and initial conditions on starting channel balances.

Payment routing optimization includes using the trained GNN model during the Lightning Network payment routing process to make optimized routing decisions. Lightning node software computes a shortest path solution when organizing payment paths, although the shortest path might not be a valid path due to, for example, liquidity constraints, channel depletion, and so on. Consequently, multiple attempts may be required to find a viable path. In this regard, the outputs from the GNN model can be fed into a pathfinding algorithm (e.g., implemented in Lightning node software) to improve prioritization of paths and optimize payment cost and latency.

Accordingly, the present disclosure describes systems and methods in which deep learning can be used to augment the efficiency of the Lightning Network. GNNs can learn latent representations of nodes and channels that can be used to infer channel balances, and eventually be used to optimize other channel management techniques, including reliability in sending/receiving payments, as well as optimize routing fees for nodes.

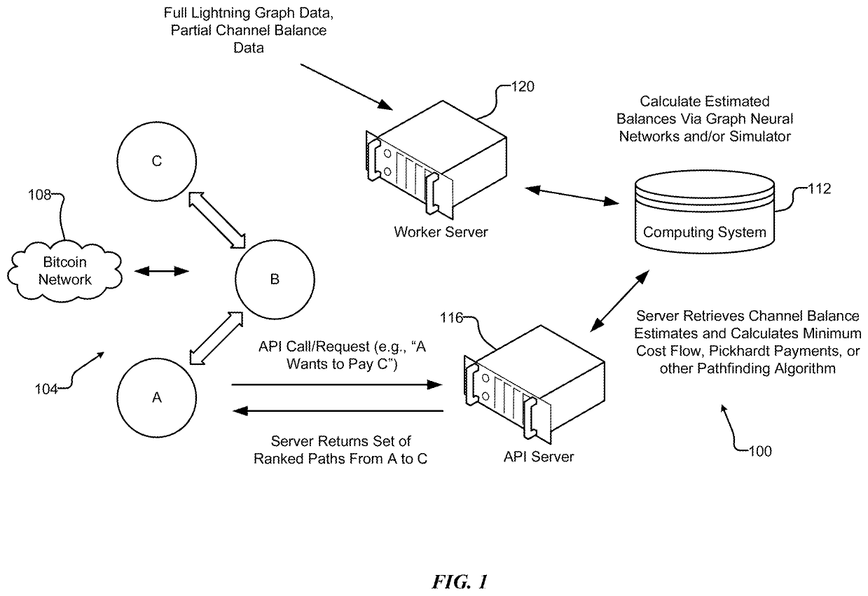

FIG. 1 shows an example transaction management system 100, according to the present disclosure. As described herein, the system 100 includes and/or is configured to communicate with a cryptocurrency transaction system, such as a Lightning Network (LN) 104. The LN 104 enables off-chain, peer-to-peer transactions (i.e., directly between users A, B, C, etc. independent of a Bitcoin network 108). For example, a transaction between users typically requires transmission of a transaction request to the Bitcoin network 108, which verifies and adds the transaction to a Bitcoin blockchain. Such transactions have associated fees and delays. The LN 104 enables transactions directly between users or between chains of users without requiring additional processing (and associated delays) by the Bitcoin network 108. For example, for a typical Bitcoin transaction using the Bitcoin network 108, the transaction is broadcast to the network, mining or processing is performed to add the transaction to a block in the network, other nodes in the network verify the block, and the transaction is then confirmed and can be completed.

The transaction management system 100 uses LN data associated with the users and connections between the users as inputs to a GNN (e.g., a GNN implemented by a computing system or device 112 (which may include a database) and/or a server, such as an Application Programming Interface (API) server 116). The GNN models the LN 104 as a graph (e.g., a GNN model) including a set of nodes and edges. The nodes of the graph represent users in the LN 104 while the edges represent connections between respective users. The computing system 112 is configured to train and execute the GNN model (e.g., using deep learning or other machine learning (ML) techniques) to rank or score paths between users in the LN 104, calculate an optimal path for a transaction between the users, etc., as described below in more detail. As used herein, “users,” “user nodes,” and/or “LN nodes” may refer to nodes of the LN 104 while “GNN nodes” refers to nodes represented graphically in the GNN.

As one example, the transaction management system 100 (e.g., the computing system 112) receives available LN data (e.g., as a snapshot, via a worker server 120) and constructs the GNN model based on the received LN data. The available LN data may include, for example, data associated with respective LN nodes, such as a node identifier, a balance of the node (i.e., an amount of Bitcoin the associated user has available to spend), a capacity of the node, a time that the information of the LN node was last updated, and a list of features the LN node supports. The capacity of the LN node corresponds to a total amount of Bitcoin available to the user, including Bitcoin held in channels/connections with other LN nodes. Accordingly, the capacity of the LN node is indicative of an amount of Bitcoin that can be routed through that LN node and depends upon the number of channels between the LN node and other LN nodes (and the capacity/balances of those LN nodes).

The LN data received from the LN 104 (i.e., corresponding to data that is actually available) may be limited. For example, data of only some of the LN nodes may be available. Data such as balances, capacities, etc. may not be available for all of the LN nodes. Accordingly, the LN data actually received from the LN 104 by the transaction management system 100 may be referred to as limited or partial LN data. The transaction management system 100 according to the present disclosure is configured to train and execute the GNN using inputs based on only the partial data available from the LN 104. For example, the transaction management system 100 is configured to calculate estimated or predicted balances for each of the LN nodes (represented in the GNN as GNN nodes) based on the partial data, transaction data (including successful and unsuccessful transactions between users via the LN 104), probing data, etc., and generate edges between the GNN nodes. Each of the GNN nodes may incorporate a node feature matrix, an adjacency matrix, and/or the like.

Conversely, the edges may correspond to one or more vectors (e.g., bi-directional vectors corresponding to possible transactions in both directions) between adjacent LN nodes. As one example, each vector may indicate a predicted balance/distribution across the adjacent LN nodes. For example, for any given pair of adjacent LN nodes, an overall balance (and therefore amount available for a transaction passing through the LN nodes) may not be equally distributed between the LN nodes. An unequal distribution of the overall balance (e.g., 90% or more attributed to one LN node with 10% or less attributed to the other LN node) may indicate that a transaction routed through a corresponding pair of LN nodes may have less likelihood of being successful than a transaction routed through a pair of LN nodes having a more equal distribution (e.g., each of the LN nodes having 50% of the overall balance of the pair of LN nodes). Accordingly, the edges of the GNN according to the present disclosure do not simply represent the presence of an existing channel or connection between two LN nodes but instead additionally indicate a balance distribution between the two LN nodes. In other words, outputs of the GNN include channel balance estimates indicating channel balance relationships between LN nodes.

In an example, while some data may be obtained voluntarily, the transaction management system 100 may determine or estimate other data using various probing mechanisms. For example, the transaction management system 100 may be configured to execute or generate fake (e.g., mock or simulated) payment requests. Success or failure of such requests may be indicative of LN node and channel balances. For example, a successful payment request indicates that a particular LN node and/or channel has sufficient funds to fulfill the request, while a failed payment indicates that the LN node and/or channel does not have sufficient funds to fulfill the request. In this manner, multiple requests for different values will provide information indicative of minimum and maximum transactions that can be completed by a particular LN node or along a particular path between LN nodes.

In another example, the transaction management system 100 may incorporate (e.g., in each vector) balance changes over time. For example, LN node and channel balances may have a sinusoidal or other variable pattern that may be represented using time-series data, a time-series model, etc. Accordingly, the channel balance estimates may be calculated further based on flow of balances over time.

The transaction management system 100 receives information associated with a request for a transaction from the LN 104 (e.g., via an API call/request routed through and processed by the API server 116). For example, a request may indicate a request from user A to pay user C. The transaction management system 100 (e.g., the API server 116, the computing system 112, or a combination thereof) retrieves and analyzes the channel balance estimates and other outputs (e.g., other information contained in the vectors) from the GNN and calculates an optimal path (or, for example, multiple paths that are ranked or scored) for the transaction from user A to user C. In one example, the transaction management system 100 executes a pathfinding algorithm using the channel balance estimates to calculate one or more paths from user A to user C.

The pathfinding algorithm may implement a minimum cost flow calculation, probabilistic models (such as a Pickhardt Payment model), interpolation (e.g., interpolation of unknown data, such as channel balances, from known channel balances), shortest path calculations (e.g., Dijkstra's Algorithm), and/or other techniques configured to calculate paths between LN nodes using outputs of the GNN. Paths may be ranked or scored based on length (i.e., a number of LN nodes between the users in that path), a confidence in channel balance estimates along the path, likelihood of sufficient funds in the path to complete the transaction, balance distribution equality/inequality along the path, etc.

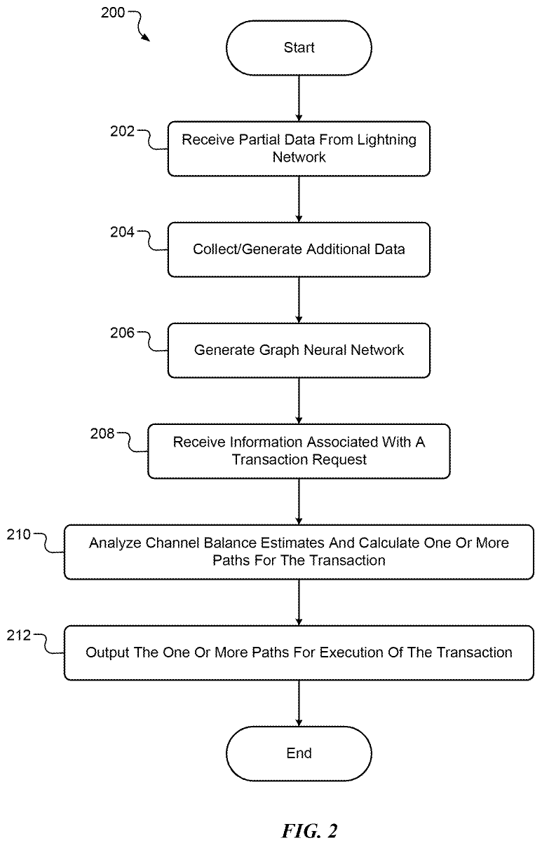

FIG. 2 illustrates steps of an example method 200 for managing transactions over a Lightning Network, according to the present disclosure. For example, the method 200 may be executed by one or more components, individually or collectively, of the transaction management system 100. At 204, the method 200 receives available (e.g., partial) LN data from the LN 104 (and/or from other sources). The received data may include, but is not limited to, data associated with respective LN nodes and channels. At 208, the method 200 obtains (e.g., collects and/or generates) additional data indicative of channel balances of the LN 104. For example, the additional data may include, but is not limited to, data interpolated from the partial data, data obtained using probing techniques as described above, time-series data (e.g., using previously obtained/generated data stored in the worker server 120, the computing system 112, etc.), and other suitable data.

At 212, the method 200 generates a GNN based on the partial data and the additional data. The GNN includes GNN nodes corresponding to respective LN nodes and edges corresponding to connections/channels between the LN nodes as described above. The edges may include vectors as described above. For example, the vectors may include at least channel balance estimates and balance distributions.

At 216, the method 200 receives information associated with a request for a transaction from the LN 104 (e.g., a request from a first user to pay a second user). At 220, the method 200 analyzes the channel balance estimates and other information contained in the GNN and calculates one or more paths for the transaction. At 224, the method 200 outputs information regarding the one or more paths for execution (e.g., by the LN 104). For example, the method 200 may output a calculated optimal path to the LN 104, which executes the transaction in accordance with the calculated optimal path. In another example, the method 200 may output more than one path and the LN 104 is configured to select one of the calculated paths and execute the transaction accordingly.

Accordingly, methods according to the present disclosure optimize payment routing between LN nodes in the LN 104 to facilitate Bitcoin transactions. For example, payment routing is optimized by generating a GNN using only partial data obtained from the LN 104 and optimizing payment routing between the LN nodes based on the GNN. Although described with respect to the Bitcoin network and an associated Lightning Network, the principles of the present disclosure may be implemented in other types of second-layer payment protocol networks and cryptocurrency networks.

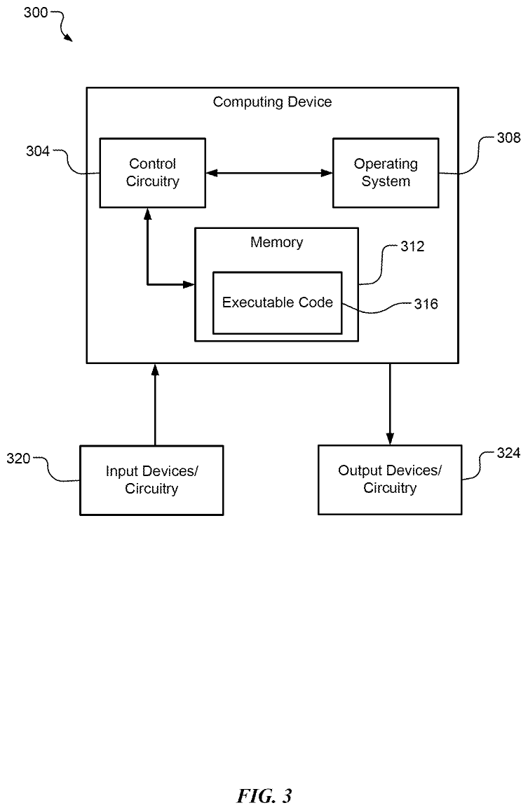

FIG. 3 shows a block diagram of an example computing device 300 configured to (and/or including circuitry configured to) implement functions of the systems and methods described herein, according to the present disclosure. For example, the computing device 300 may implement or be implemented by the one or more components of the transaction management system 100, including, but not limited to, the computing system 112, the servers 116/120, etc., respectively, or collectively. Systems described herein may implement a single computing device, a plurality of computing devices, etc. configured to individually and/or collectively perform functions related to the systems and methods of the present disclosure.

The computing device 300 may include control circuitry 304 that may be, for example, one or more processors or processing devices, a central processing unit processor (CPU), an integrated circuit or any suitable computing or computational device, an operating system 308, memory 312, executable code 316, input devices or circuitry 320, and output devices or circuitry 324. The control circuitry 304 (or one or more controllers or processors, possibly across multiple units or devices) may be configured to implement functions of the systems and methods described herein. More than one of the computing devices 300 may be included in, and one or more of the computing devices 300 may act as the components of, a system according to embodiments of the disclosure. Various components of the computing device 300 may be implemented with same or different circuitry, same or different processors or processing devices, etc.

The operating system 308 may be or may include any code segment (e.g., one similar to the executable code 316 described herein) designed and/or configured to perform tasks involving coordination, scheduling, arbitration, supervising, controlling or otherwise managing operation of the control circuitry 304 (e.g., scheduling execution of software programs or tasks or enabling software programs or other hardware modules or units to communicate). The operating system 308 may be a commercial operating system. The operating system 308 may be an optional component (e.g., in some embodiments, a system may include a computing device that does not require or include the operating system 308). For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

The memory 312 may be or may include, for example, Random Access Memory (RAM), read only memory (ROM), Dynamic RAM (DRAM), Synchronous DRAM (SD-RAM), a double data rate (DDR) memory chip, Flash memory, volatile memory, non-volatile memory, cache memory, a buffer, a short term memory unit, a long term memory unit, or other suitable memory units or storage units. The memory 312 may be or may include a plurality of memory units, which may correspond to same or different types of memory or memory circuitry. The memory 312 may be a computer or processor non-transitory readable medium, or a computer non-transitory storage medium, e.g., RAM.

The executable code 316 may be any executable code, e.g., an application, a program, a process, task, or script. The executable code 316 may be executed by the control circuitry 304, possibly under control of the operating system 308. Although, for the sake of clarity, a single item of the executable code 316 is shown, a system according to some embodiments of the disclosure may include a plurality of executable code segments similar to the executable code 316 that may be loaded into the memory 312 and cause the control circuitry 304 to carry out methods described herein. Where applicable, the terms “process” and “executable code” may be used interchangeably herein. For example, verification, validation and/or authentication of a process may mean verification, validation and/or authentication of executable code.

In some examples, the memory 312 may include non-volatile memory having the storage capacity of a storage system. In other examples, the computing device 300 may include or communicate with a storage system and/or database. Such a storage system may include, for example, flash memory, memory that is internal to, or embedded in, a micro controller or chip, a hard disk drive, a solid-state drive, a CD-Recordable (CD-R) drive, a Blu-ray disk (BD), a universal serial bus (USB) device or other suitable removable and/or fixed storage unit. Content may be stored in the storage system and loaded from the storage system into the memory 312 where it may be processed by the control circuitry 304.

The input circuitry 320 may be or may include any suitable input devices, components, or systems, e.g., physical sensors such as accelerometers, thermometers, microphones, analog to digital converters, etc., a detachable keyboard or keypad, a mouse, etc. The output circuitry 740 may include one or more (possibly detachable) displays or monitors, motors, servo motors, speakers and/or any other suitable output devices. Any applicable input/output (I/O) devices may be connected to the control circuitry 304. For example, a wired or wireless network interface card (NIC), a universal serial bus (USB) device, or external storage device may be included in the input circuitry 320 and/or the output circuitry 324. It will be recognized that any suitable number of input devices and output devices may be operatively connected to the control circuitry 304. For example, the input circuitry 320 and the output circuitry 324 may be used by a technician or engineer in order to connect to the control circuitry 304, update software, and the like.

Embodiments may include an article such as a computer or processor non-transitory readable medium, or a computer or processor non-transitory storage medium, such as for example memory, a disk drive, or USB flash memory, encoding, including or storing instructions (e.g., computer-executable instructions, which, when executed by a processor or controller, carry out methods disclosed herein), a storage medium such as the memory 312, computer-executable instructions such as the executable code 316, and a controller such as the control circuitry 304.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the disclosure may include components such as, but not limited to, a plurality of central processing units (CPU) or any other suitable multi-purpose or specific processors or controllers (e.g., controllers similar to the control circuitry 304), a plurality of input units, a plurality of output units, a plurality of memory units, and a plurality of storage units, etc. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on board system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as the control circuitry 304.

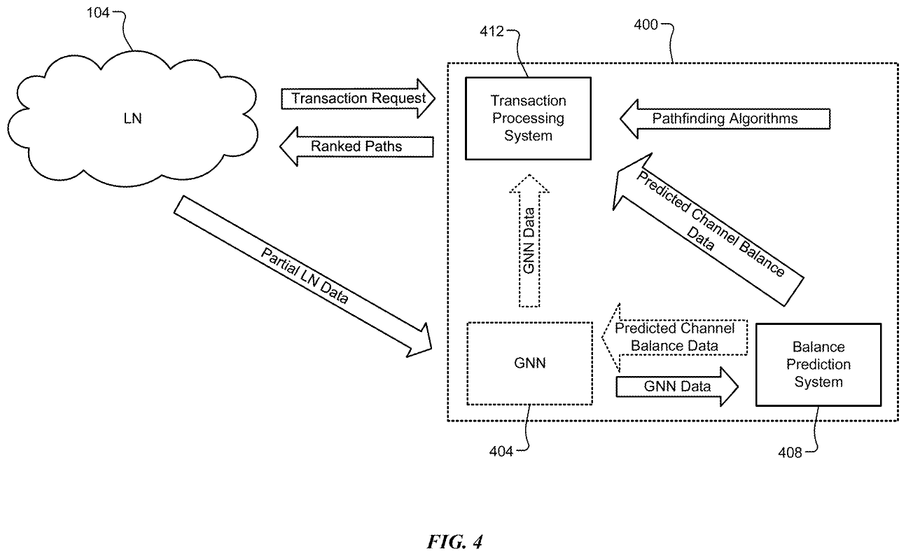

FIG. 4 shows a functional block diagram of an example transaction management system 400, according to the present disclosure. For example, the transaction management system 400 may correspond to the transaction management system 100 of FIG. 1 and may include the same or similar components (shown schematically) as the transaction management system 100. The transaction management system 400 is configured to implement functions of the present disclosure described above in FIGS. 1-3 and further described below in more detail, including, but not limited to, communicating with the LN 104 to receive partial data, generating a GNN 404 representing the LN 104, predicting additional data (e.g., predicted channel balance data) based on the GNN 404 (e.g., based on GNN data describing the GNN 404), and generating and outputting one or more transaction paths through the LN 104 based on the predicted channel balance data. All or portions of the transaction management system 400 may be implemented by a computing device, such as the computing device 300 described above in FIG. 3, one or more of computing devices configured to individually and/or collectively perform the functions (e.g., using one or more processors as defined herein), and so on. When implemented by more than one computing device, the computing devices may be located in a single location or multiple locations (e.g., implemented using a cloud computing system, using one or more connected servers, using a distributed communication system such as the Internet, and so on).

For example, the transaction management system 400 receives partial LN data from the LN 104, which may be received by or other otherwise input to the GNN 404. The GNN 404 is configured to generate at least one graphical representation of the partial LN data. In an embodiment, the partial LN data includes data identifying the LN nodes of the LN 104, relationships (e.g., established channels) between the LN nodes of the LN 104, and channel capacity/balance. A channel capacity between two LN nodes may be an estimate of an overall channel capacity representing a total of individual channel capacities in either direction between the nodes. For example, while the overall channel capacity between two LN nodes may be estimated to be 350,000 (e.g., dollars or other units), actual individual channel capacities are unknown. Accordingly, the GNN 404 includes a graph representing the LN 104 as GNN nodes and representing channels between the LN nodes as edges. Initially, the edges may only be assigned respective overall channel capacities.

The transaction management system 400 includes a balance prediction system 408 configured to calculate the individual channel capacities (e.g., predicted channel balance data) based on data contained in the generated graph (e.g., based on GNN data output by the GNN 404). The predicted channel balance data may correspond to the additional data described above, such as the additional data obtained at 208 of the method 200. The balance prediction system 408 may generate the predicted channel balance data by interpolating the partial LN data (e.g., interpolating the overall channel capacities contained in the graph), performing various probing techniques on the LN 104 as described above, analyzing time-series data, and so on. In some examples, the balance prediction system 404 provides the predicted channel balance data to the GNN 404, which updates the graph based on the predicted channel balance data. In other examples, the balance prediction system 404 provides the predicted channel balance data directly to a transaction processing system 412 as described below.

The transaction processing system 412 is configured to receive transaction requests from the LN 104 and communicate with the GNN 404 and/or the balance prediction system 408 to receive the predicted channel balance data. In one example, the transaction processing system, in response to receiving a transaction request, retrieves/requests the predicted channel balance data directly from the balance prediction system. For example, the balance prediction system 408 may be configured to provide only predicted channel balance data relevant to a particular transaction request (e.g., predicted channel balance data for channels between GNN nodes coupled to the LN nodes involved in the requested transaction). In another example, the GNN 404 may be configured to update the graph based on the predicted channel balance data as described above. Accordingly, in this example, the transaction processing system 412 is configured to receive the GNN data from the GNN 404, which may include the predicted channel balance for the entire graph, for only LN nodes involved in the transaction, etc.

The transaction procession system 412 is configured to calculate one or more paths (“transaction paths”) for the requested transaction based on the predicted channel balance data. For example, the transaction processing system 412 is configured to implement one or more pathfinding algorithms (as described above), which are applied to the GNN data and the predicted channel balance data to calculate paths between the LN nodes involved in the requested transaction. The transaction processing system 412 outputs information regarding the one or more paths for execution by the LN 104. For example, the transaction processing system 412 outputs a calculated optimal or highest ranked path to the LN 104. In another example, the transaction processing system 412 outputs one or more ranked paths to the LN 104, which selects one of the ranked paths (e.g., the highest-ranked path) and executes the transaction in accordance with the selected ranked path.

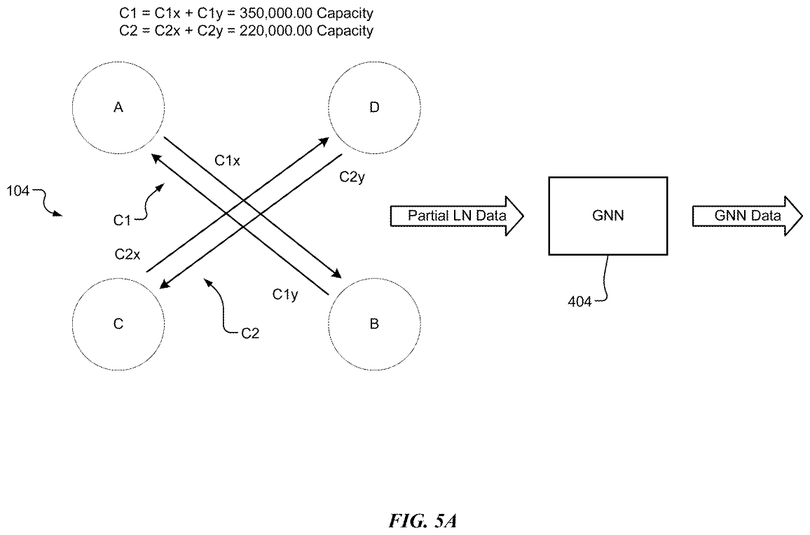

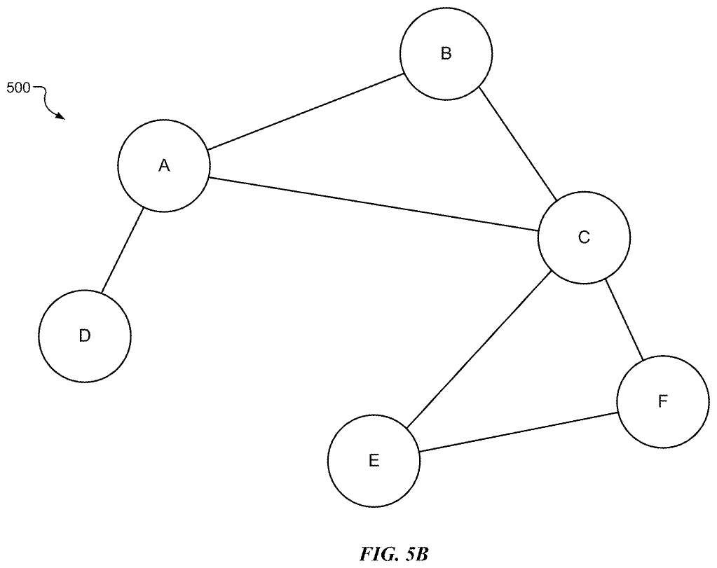

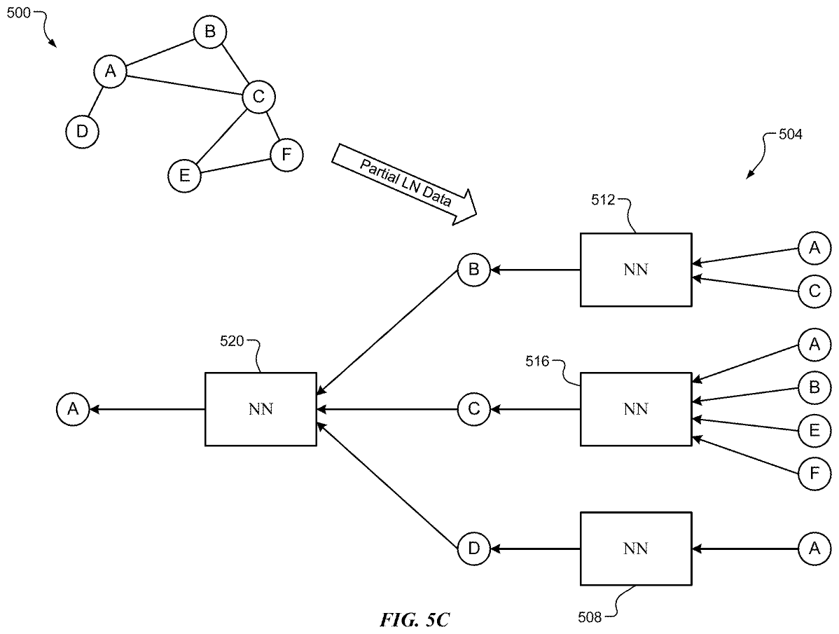

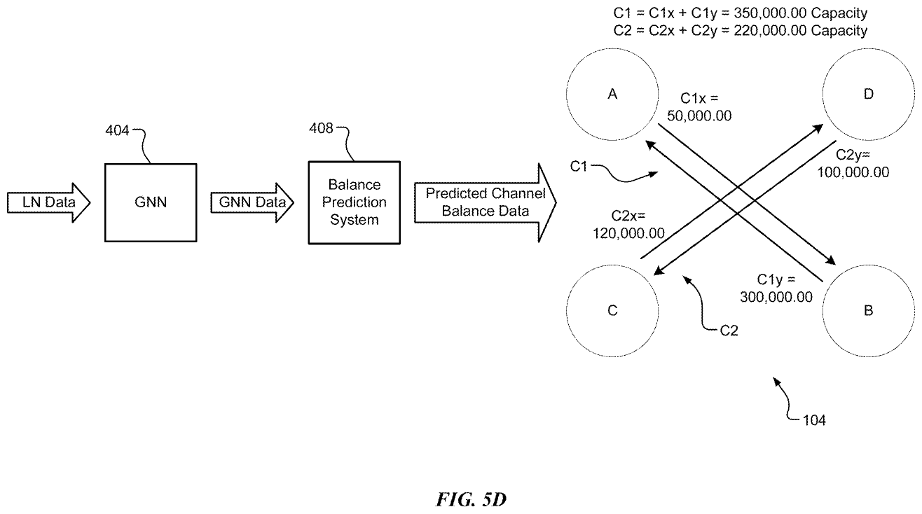

FIG. 5A illustrates an example of the LN 104 including LN nodes A, B, C, and D, a channel C1 between LN nodes A and B, and a channel C2 between LN nodes C and D. Generally, a given channel between two LN nodes includes two unidirectional individual channels (e.g., “directed channels,” represented by directed edges in a graph generated by the GNN 404). For example, the channel C1 may include a first directed channel C1x corresponding to an amount available (i.e., a capacity) for transfer from LN node A to LN node B and a second directed channel C1y corresponding to an amount available for transfer from LN node B to LN node A. Similarly, For example, the channel C2 may include a first directed channel C2x corresponding to an amount available for transfer from LN node C to LN node C and a second directed channel C2y corresponding to an amount available for transfer from LN node D to LN node C.

However, only an estimated overall channel capacity may be known. The overall channel capacity for a given channel C corresponds to a sum of the capacities of the directed channels. In this example, the estimated overall capacity of the channel C1 is 350,000.00, while the estimated overall capacity of the channel C2 is 220,000.00. Since these estimated capacities are for the overall channel capacities, capacities of the directed channels are unknown, and therefore amounts available for actual transfer in each direction between the LN nodes are unknown. In other words, a total capacity available to LN nodes A and B may be known but respective capacities of the individual LN nodes A and B are unknown. Accordingly, the partial LN data provided to the GNN 404 may only include the estimated overall capacities for each channel.

FIG. 5B shows a graphical representation of partial LN data of an example LN 500 to be input to a GNN, according to the present disclosure. In this example, the LN 500 includes six LN nodes A, B, C, D, E, and F. FIG. 5C shows a portion of an example GNN 504 corresponding to channels associated with (e.g., coupled directly or indirectly to) the LN node A. In other words, the GNN 504 represents only a portion of GNN generated to represent the LN 500. Similar graphical representations may be generated for each of the other LN nodes in the LN 500 (i.e., B, C, D, E, and F). Accordingly, for any given LN node involved in a transaction request, the GNN 504 is configured to provide graph data representing relationships between the LN node and all other LN nodes directly or indirectly coupled to the LN node. As shown, LN node A is: directly coupled to LN nodes B, C, and D; indirectly coupled to LN node B via LN node C; indirectly coupled to LN node C via LN node B; indirectly coupled to LN node E via LN node C, via LN nodes B and C, via LN nodes B, C, and F, and via LN nodes C and F; and indirectly coupled to LN node F via LN node C, via LN nodes B and C, via LN nodes B, C, and E, and via LN nodes C and E. As such, for any given transaction involving LN node A, there may be one or more possible paths between LN node A and respective other LN nodes.

Accordingly, the GNN 504 illustrates aggregated relationships between LN node A and the LN nodes B, C, D, E, and F. The GNN 504 includes a plurality of neural networks (NNs) each configured to aggregate data corresponding to channels established between LN node A and respective LN nodes coupled directly to LN node A (i.e., LN nodes B, C, and D). For example, an NN 508 is configured to aggregate and output channel balance data indicative of a channel established between LN nodes A and D. In this example, since the only path between LN nodes A and D corresponds to a single channel (and D is not coupled to any of the other LN nodes), the channel balance data output by the NN 508 may only include channel balance data indicative of the overall channel balance associated with the relationship between LN nodes A and D.

Conversely, an NN 512 is configured to aggregate and output channel balance data indicative of channels established between LN nodes A and B and between C and B. Accordingly, the channel balance data output by the NN 512 includes channel balance data indicative of a more complex (i.e., relative to the channel balance data output by the NN 508) relationship between channel balances associated with the LN nodes A, B, and C. In other words, since a channel balance for the channel between LN nodes A and B can be determined separate from a channel balance for the channel being LN nodes C and B, some assumptions can be made regarding relative channel balances. As a simplified example, if the channel between the LN nodes A and B (e.g., A+B) has a channel balance less than that of the channel between LN nodes B and C (e.g., B+C), then it can be assumed that A+B<B+C, and therefore A<C.

Similarly, an NN 516 is configured to aggregate and output channel balance data indicative of channels established between LN nodes A and C, B and C, E and C, and F and C. An NN 520 receives outputs of each of the NNs 508, 512, and 516 and aggregates and outputs channel balance data indicative of all channel balances between LN node A and any LN node in the LN 500 coupled to the LN node A. Outputs of the NNs 508, 512, 516, and 520 correspond to GNN data output by the GNN 404. Accordingly, the GNN data includes aggregated channel balance data indicative of channel balances between the LN nodes of the LN 104.

FIG. 5D shows an example of the LN 104 with corresponding predicted channel balance data, according to the present disclosure. For example, the GNN data generated and output by the GNN 404 is provided to the balance prediction system 408 as described above. The balance prediction system 408 calculates the predicted channel balance data including the individual channel capacities based on the GNN data. In other words, the balance prediction system 408 is configured to analyze the aggregated channel balance data indicative of the channel balances between the LN nodes of the LN 104 and, based on the aggregated channel balance data, calculate the predicted channel balance data.

For example, as described above in FIG. 5A, the estimated overall capacity of the channel C1 is 350,000.00 while the estimated overall capacity of the channel C2 is 220,000.00. However, in contrast to the partial LN data, the predicated channel balance data includes predictions of the respective capacities of the directed edges of the individual LN nodes A, B, C, and D (i.e., values of C1x, C1y, C2x, and C2y). In this example, the predicted channel balance data includes values of C1x=50,000.00, C1y=300,000.00, C2x=120,000.00, and C2y=120,000.00. In other words, an amount of 300,000.00 is available for transfer in a direction from LN node B to LN node A while an amount of only 50,000.00 is available for transfer in a direction from LN node A to LN node B. Conversely, an amount of 120,000.00 is available for transfer in a direction from LN node C to LN node D while an amount of only 100,000.00 is available for transfer in a direction from LN node D to LN node A. In this manner, the predicted channel balance data includes predicted channel balances for each directed edge. Accordingly, paths for a transaction between LN nodes can be more accurately calculated.

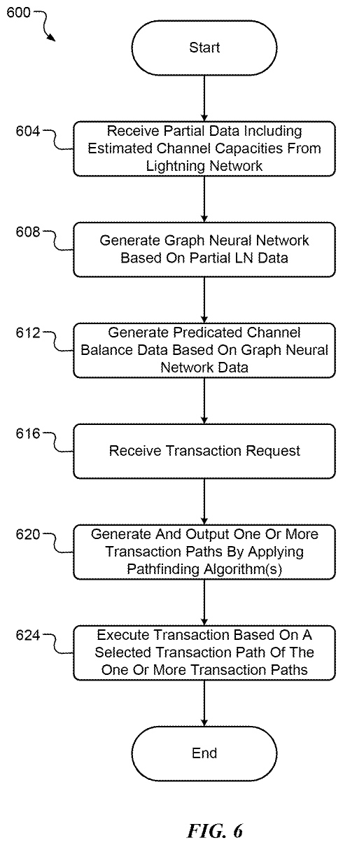

FIG. 6 illustrates steps of another example method 600 for managing transactions over a Lightning Network, according to the present disclosure. For example, the method 600 may be executed by one or more components, individually or collectively, of the transaction management system 400.

At 604, the method 600 (e.g., the transaction management system 400, at a computing device configured generate a GNN) includes the step of receiving the partial LN data including at least data identifying the LN nodes of the LN 104, relationships between the LN nodes, and estimated channel capacity/balance. The estimated channel capacity between two LN nodes corresponds to an estimate of an overall channel capacity representing a total of individual channel capacities in either direction between the LN nodes but may not include respective amounts of the individual, unidirectional channel capacities as described above.

At 608, the method 600 (e.g., a computing device of the transaction management system 400) includes the step of generating a GNN of the LN 104 based on the partial LN data. The GNN represents the LN nodes as GNN nodes and represents channels between the LN nodes as directed edges. Overall channel capacities included in the partial LN data may be assigned to respective pairs of directed edges.

At 612, the method 600 (e.g., the balance prediction system 408) includes the step of generating predicted channel balance data based on the GNN (i.e., the GNN of the partial LN data, as indicated by GNN data output from the GNN). For example, the method 600 analyzes the aggregated channel balance data of the GNN as described above and, based on the aggregated channel balance data, calculates the predicted channel balance data. In some examples, the GNN is updated in accordance with the predicted channel balance data. In other examples, the predicted channel balance data may be provided (e.g., from the balance prediction system 408 to the transaction processing system 412) in response to a transaction request.

At 616, the method 600 (e.g., the transaction processing system 412) includes the step of receiving a transaction request corresponding to a request to process a LN transaction. At 620, the method 600 (e.g., the transaction processing system 412) includes the step of generating and outputting one or more transaction paths. For example, the transaction processing system 412 is configured to apply one or more pathfinding algorithms to the GNN data, the predicted channel balance data, and information associated with the transaction request (e.g., source and target LN nodes, amount of the transaction, etc.) to calculate the one or more transaction paths as described above. The transaction processing system 412 may output a calculated optimal or highest ranked path, outputs two or more ranked paths, and so on.

At 624, the method 600 (e.g., the LN 104) includes the step of executing the LN transaction based on the output of the transaction processing system 412. For example, in embodiments where the transaction processing system 412 outputs only a single transaction path, the LN 104 executes the transaction in accordance with the single transaction path. Conversely, in embodiments where the transaction processing system 412 outputs two or more ranked paths, the transaction processing system 412 may select one of the ranked paths and executes the transaction in accordance with the selected path.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrases “at least one of A, B, and C” and “at least one of A, B, or C” should be construed to mean a logical (A OR B OR C), using a non-exclusive logical OR, and should not be construed to mean “at least one of A, at least one of B, and at least one of C.”

The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one or more processors configured to perform actions A, B, and C. In addition, “A processor” configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

What is claimed is:

1. A method for managing a transaction, the method comprising, by a computing device:
receiving information from a second-layer payment protocol network configured to process transactions between users associated with a cryptocurrency network, wherein the information includes partial data indicating at least one of (i) balances associated with user nodes in the second-layer payment protocol network or (ii) balances associated with channels between two or more of the user nodes;
obtaining, from the partial data, additional data indicative of the at least one of the balances associated with the user nodes or the balances associated with the channels;
generating a graph neural network (GNN) based on the partial data and the additional data;
receiving information associated with a requested transaction between first and second user nodes in the second-layer payment protocol network; and
in response to the information associated with the requested transaction, (i) calculating one or more paths for the transaction between the first user node and the second user node based on outputs of the GNN and (ii) outputting the one or more paths for execution of the transaction.

2. The method of claim 1, wherein receiving the information from the second-layer payment protocol network includes receiving data associated with each of the user nodes, and wherein the data associated with each of the user nodes includes at least one of a node identifier, a balance of the user node, a capacity of the user node, a time that the data was last updated, and list of features supported by the user node.

3. The method of claim 1, wherein obtaining the additional data includes at least one of performing interpolation on the partial data, performing a probing operation of the second-layer payment protocol network, and obtaining time-series data associated with the partial data.

4. The method of claim 1, wherein generating the GNN includes constructing a graph comprised of (i) a plurality of GNN nodes, wherein each of the plurality of GNN nodes corresponds to a respective one of the user nodes, and (ii) a plurality of edges between adjacent ones of the plurality of GNN nodes, wherein each of the plurality of edges corresponds to a respective channel between adjacent ones of the user nodes.

5. The method of claim 4, wherein each of the plurality of edges includes at least one vector identifying a distribution of a balance between corresponding ones of the plurality of GNN nodes.

6. The method of claim 1, wherein calculating the one or more paths includes assigning a respective rank to each of the one or more paths.

7. The method of claim 1, wherein the second-layer payment protocol network comprises the Lightning Network, and wherein the cryptocurrency network comprises the Bitcoin network.

8. A transaction management system, comprising:
a computing device configured to:
receive information from a second-layer payment protocol network configured to process transactions between users associated with a cryptocurrency network, wherein the information includes partial data indicating at least one of (i) balances associated with user nodes in the second-layer payment protocol network or (ii) balances associated with channels between two or more of the user nodes;
obtain, from the partial data, additional data indicative of the at least one of the balances associated with the user nodes or the balances associated with the channels;
generate a graph neural network (GNN) based on the partial data and the additional data;
receive information associated with a requested transaction between first and second user nodes in the second-layer payment protocol network; and
in response to the information associated with the requested transaction, (i) calculate one or more paths for the transaction between the first user node and the second user node based on outputs of the GNN and (ii) output the one or more paths for execution of the transaction; and
a storage device configured to store the GNN.

9. The transaction management system of claim 8, wherein, to receive the information from the second-layer payment protocol network, the computing device is configured to receive data associated with each of the user nodes, and wherein the data associated with each of the user nodes includes at least one of a node identifier, a balance of the user node, a capacity of the user node, a time that the data was last updated, and list of features supported by the user node.

10. The transaction management system of claim 8, wherein, to obtain the additional data, the computing device is configured to at least one of perform interpolation on the partial data, perform a probing operation of the second-layer payment protocol network, and obtain time-series data associated with the partial data.

11. The transaction management system of claim 8, wherein, to generate the GNN, the computing device is configured to construct a graph comprised of (i) a plurality of GNN nodes, wherein each of the plurality of GNN nodes corresponds to a respective one of the user nodes and (ii) a plurality of edges between adjacent ones of the plurality of GNN nodes, wherein each of the plurality of edges corresponds to a respective channel between adjacent ones of the user nodes.

12. The transaction management system of claim 11, wherein each of the plurality of edges includes at least one vector identifying a distribution of a balance between corresponding ones of the plurality of GNN nodes.

13. The transaction management system of claim 8, wherein, to calculate the one or more paths, the computing device is configured to assign a respective rank to each of the one or more paths.

14. The transaction management system of claim 8, wherein the second-layer payment protocol network comprises the Lightning Network, and wherein the cryptocurrency network comprises the Bitcoin network.

15. A non-transitory computer readable storage medium configured to store instructions that, when executed by a processor included in a computing device, cause the computing device to carry out steps that include:
receiving information from a second-layer payment protocol network configured to process transactions between users associated with a cryptocurrency network, wherein the information includes partial data indicating at least one of (i) balances associated with user nodes in the second-layer payment protocol network or (ii) balances associated with channels between two or more of the user nodes;
obtaining, from the partial data, additional data indicative of the at least one of the balances associated with the user nodes or the balances associated with the channels;
generating a graph neural network (GNN) based on the partial data and the additional data;
receiving information associated with a requested transaction between first and second user nodes in the second-layer payment protocol network; and
in response to the information associated with the requested transaction, (i) calculating one or more paths for the transaction between the first user node and the second user node based on outputs of the GNN and (ii) outputting the one or more paths for execution of the transaction.

16. The non-transitory computer readable storage medium of claim 15, wherein receiving the information from the second-layer payment protocol network includes receiving data associated with each of the user nodes, and wherein the data associated with each of the user nodes includes at least one of a node identifier, a balance of the user node, a capacity of the user node, a time that the data was last updated, and list of features supported by the user node.

17. The non-transitory computer readable storage medium of claim 15, wherein obtaining the additional data includes at least one of performing interpolation on the partial data, performing a probing operation of the second-layer payment protocol network, and obtaining time-series data associated with the partial data.

18. The non-transitory computer readable storage medium of claim 15, wherein generating the GNN includes constructing a graph comprised of (i) a plurality of GNN nodes, wherein each of the plurality of GNN nodes corresponds to a respective one of the user nodes and (ii) a plurality of edges between adjacent ones of the plurality of GNN nodes, wherein each of the plurality of edges corresponds to a respective channel between adjacent ones of the user nodes.

19. The non-transitory computer readable storage medium of claim 18, wherein each of the plurality of edges includes at least one vector identifying a distribution of a balance between corresponding ones of the plurality of GNN nodes.

20. The non-transitory computer readable storage medium of claim 15, wherein calculating the one or more paths includes assigning a respective rank to each of the one or more paths.

21. The non-transitory computer readable storage medium of claim 15, wherein the second-layer payment protocol network comprises the Lightning Network, and wherein the cryptocurrency network comprises the Bitcoin network.
